(19) United States
(12) Patent Application Publication
(10) Pub. No.: US 2002/0071149 A1
(43) Pub. Date: Jun. 13, 2002

(54) Apparatus and method for protection of an asynchronous transfer mode passive optical network interface

(76) Inventors: Dexiang John Xu, Suwanee, GA (US); Wei Yen, Dunwoody, GA (US); Elton Ho, Norcross, GA (US)

Correspondence Address: Stanley H. Thompson, Morrison & Foerster LLP, Suite 3500, 555 West Fifth Street, Los Angeles, CA, 90013-1024, US

(21) Appl. No.: 09/864,671

(22) Filed: May 24, 2001

Related U.S. Application Data
(60) Provisional application No. 60/254,913, filed on Dec. 12, 2000.

(51) Int. Cl. H04B 10/08; H04B 10/20; H04J 14/00

(52) U.S. Cl. 359/110; 359/118; 370/216

(57) ABSTRACT

A method and apparatus for protecting faults in an optical network. Protection is based on 1:n protection at an Optical Line Terminator (“OLT”). Each working interface module in the OLT is coupled via a fiber to a 2:N splitter which provides communication with N Optical Network Units (“ONU”). A protection interface module is coupled via a fiber to a 1:n switch whose output is coupled to each of the 2:N splitters. In the event of a fiber break, protection switching is performed by forming a backup link to the 2:N splitter associated with the failed fiber through the protection interface module. The 1:n protection arrangement may be replicated and extended to a g*(1:n) protection arrangement. A uni-ranging process speeds up protection switching by ranging only one ONU associated with a failed fiber, rather than all ONUs associated with a failed fiber.

This application claims the benefit of U.S. Provisional Application No. 60/254,913, filed Dec. 12, 2000.

### BACKGROUND OF THE INVENTION

This invention is directed toward automatic protection switching in an asynchronous transfer mode passive optical network (APON). More specifically, the present invention is directed toward a protection method and APON architecture that efficiently protects against system faults, such as a fiber cut, in the network. The present invention also includes a method for rapidly acquiring phase equalization data needed to complete a protection switching operation.

Delivering broadband data through fiber directly to the home is becoming a commercial reality. However, the cost of fiber-to-the-home (FTTH) deployment has been one of the major obstacles to hinder the fast pace of FTTH deployment. Designing reliable and cost effective APON access network equipment has been a challenge for telecommunication engineers. In order to eliminate a single point of failure, protection mechanisms must be incorporated. Protection methods for an APON interface have recommended previously. However, previously proposed methods may not provide suitable tradeoffs between reliability and cost.

As shown in FIG. 1, a general APON architecture 1 consists of four components, an Optical Line Terminator (OLT) 101, an Optical Distribution Network (ODN) 102, an Optical Network Unit (ONU) 103, and an Element Management System (EMS) 104. The OLT 101 functions as an asynchronous transfer mode (ATM) concentrator or edge switch with a passive optical network (PON) access interface. On the network side, the OLT 101 can connect to the ATM backbone 105 or digital cross-connect network 106 using their respective interfaces, such as OC-3c 107 or DS3 108. Each APON interface module (not shown) in the OLT 101 can support N ONUs 103, where N is defined as the splitter ratio. The ODN 102 has a tree configuration with the roots connecting to the OLT 101 and the branches distributing to the ONUs 103. The ODN 102 is completely constructed from passive optical components such as fibers 109, splitters 201, and connectors (not shown). It may typically span up to 20 km distance with certain power budget restriction. The optical signals are carried on one single fiber to the connected ONUs 103. The ONU 103 terminates the optical signal at a PON interface and converts the signal to the proper interfaces with customer premises equipment (CPE). Depending on the applications, the ONU 103 can be placed in different locations to support all FTTx configurations, such as FTTH, fiber-to-the-business (FTTB), fiber-to-the-curb (FTTC), or fiber-to-the-cabinet (FTTCab). The EMS 104 is used to manage the whole system for provisioning, performance monitoring, operation, administration, and maintenance.

APON uses several unique techniques to provide robust duplex data communication through a single fiber. To support bi-directional transmission, Wavelength Division Multiplexing (WDM) employing two lasers at different wavelengths is used in the interface. In the downstream direction, data is broadcast at a wavelength of 1550 nm for point-to-multipoint transmission. In the upstream direction, a 1310 nm wavelength is used along with a Time Division Multiple Access (TDMA) protocol to support the multipoint-to-point communication. Since all ONUs 103 on an APON interface receive the entire data stream broadcast from the OLT 101, a security measure called churning may be deployed.

The APON protocol uses standard ATM cell structures in which the most important two types of ATM cells are data and Physical Layer Operation Administration Management (PLOAM) cells. The PLOAM cells carry command, control, and status information whereas the data cells carry the payload for data communication. Since the ONUs 103 can be a significant distance from each other and the OLT 101, a process called ranging is performed prior to the start of data transmission to avoid collision. Ranging allows an OLT 101 to compensate for the time delay caused by the vast distances separating the OLT 101 and ONUs 103 with phase equalization. The ranging process is carried out through PLOAM cells sent from the OLT 101. A ranging process standard has been defined by International Telecommunication Union-Telecommunication in the publication ITU-T G.983.1 standard, the entire text of which is hereby incorporated by reference. The ranging process creates the unique requirements for automatic protection design.

Because a single APON interface module at the OLT 101 will accommodate multiple ONUs 103 in the field, the protection of APON interface modules is very important. In ITU-T G.983.1, four protection schemes have been defined as type A, B, C, and D. In the following paragraphs, each protection type is briefly discussed.

In protection type A, a spare fiber is equipped between the OLT and the splitter. The APON interface can detect a fiber cut in a primary fiber and switch to the spare fiber. During switching, signal loss or even cell loss may be inevitable. However, all the connections between the service node and the terminal equipment should be held during the fiber switching. Re-ranging of all ONUs connected may be necessary because the total fiber length may be changed. There is no redundant equipment in the OLT and ONUs. A 1:2 optical switch along with 2:N splitter is required to implement this feature. The protection switch message is reported back to the EMS. In order to reduce the reflection caused by the open end of the fiber at the optical switch, a special optical switch, an attenuator between the splitters, or APON scaling may be needed.

In protection type B, the APON network is partially protected. This configuration uses a working APON interface module and a cold stand-by protection APON interface module in the OLT side and no redundant parts in the ONUs. An APON interface module failure or a fiber cut between an OLT and a splitter will cause “tree” protection switching whereas the individual ONU PON interface failure will not cause “branch” protection switching. The signal loss or even cell loss is, in general, inevitable in the switching period. However, all the connections supported between the service node and the terminal equipment should be held after this switching. A 2:N splitter is used for this protection type. A selector at the OLT is used to switch between working and protection APON interface modules.

In protection type C, both the OLT and ONUs are equipped with redundant modules. In this case, the hot stand-by protection PON circuits in both OLT and ONU sides makes hitless switching possible. Constant synchronization between the working and protection modules is required for hitless switching. PON interface module failures at the OLT side and a fiber cut between OLT and splitter will cause a “tree” switching. Individual PON interface failures at the ONU side can be recovered by single branch switching so that other ONUs will not be disturbed. In this protection scheme, single point failure scenarios in PON interface are all covered.

In protection type D, a redundant ODN is implemented besides using a protection PON interface modules at both the OLT and ONU. In such case, Multiple Point Failure (MPF) can be protected against in the ODN. It is the most reliable PON interface. However, it carries a higher cost and the management of such a PON interface is complicated.

Protection types B and C have been recommended for APON systems for FTTB deployment. For FTTH, it is more cost effective to use types of A or B. However, type A only protects the fiber failure. On the other hand, type B with 1:1 protection at OLT side is cost prohibitive for a majority of FTTH applications because multiple redundant APON interface modules are required.

Thus, there is a need for a fault protection method and architecture for APON that is cost effective for FTTH applications.

### SUMMARY OF THE INVENTION

The present invention provides an alternative to the prior art fault protection schemes. An alternative type H protection is based on 1:n protection at the OLT. Each of n working APON interface modules in the OLT is coupled via a fiber to a 2:N splitter which provides communication with N ONUs. Also at the OLT is a protection APON interface module coupled via a fiber to a 1:n switch whose output is coupled to each of the 2:N splitters. In the event of a failure of one of the n working APONs or of one of the n fibers emanating from the working APONs (such as a fiber break), a backup link to the 2:N splitter associated with the failed working APON is established through the protection APON.

The present invention also provides a pre-ranging and uni-ranging method which speeds up automatic protection switching. Pre-ranging is performed at the system setup period or period when the least traffic is running in the system. The working APON interface modules are switched to a standby mode one by one until all n modules are switched. The equalization data obtained for the standby module will be stored in a memory. The advantage of this method is that all equalization data for the ONUs associated with each working APON interface module are readily available in the memory.

The present invention also provides a uni-ranging process for ranging during protection switching. Instead of ranging every ONU, only one ONU associated with a failed APON interface module is ranged after protection switching. Since the 1:n protection at an OLT is tree switching, the distance differences between to the various ONUs remains intact. Therefore, after protection switching, one ONU chosen from the group can be ranged first. By comparing the previous equalization data stored in the memory to the newly obtained range, the equalization data for other ONUs associated with the failed APON interface module can be calculated. Uni-ranging speeds up the automatic switching dramatically by reducing the multiple ranging processes to one.

This 1:n protection type is more economical than previously defined types. At the same time, it will supply adequate protection during Single Point of Failure (SPF). With the developed pre-ranging and uni-ranging methods discussed herein, the fast protection switching can be achieved. Such protection is suitable for an FTTH system in which the cost is the vital factor for successful and massive deployment. Therefore, it is more suitable for an FTTH application in which cost reduction is essential.

### BRIEF DESCRIPTION OF THE DRAWINGS

FIG. 1 is a plan view of an asynchronous transfer mode passive optical network;

FIG. 2 is a plan view of one embodiment an APON network using type H protection;

FIG. 3A is a plan view of an APON network using type H protection;

FIG. 3B is a plan view of an APON network using type H protection;

FIG. 4 is a plan view of an alternative embodiment of an APON network using type H protection;

FIG. 5 is a flow diagram of the protection management procedure;

FIG. 6 is a flow diagram of the uni-ranging procedure;

FIG. 7 is a plan view of an alternative embodiment of an APON network using type H protection; and

FIG. 8 is a plan view of an alternative embodiment of an APON network using type H protection.

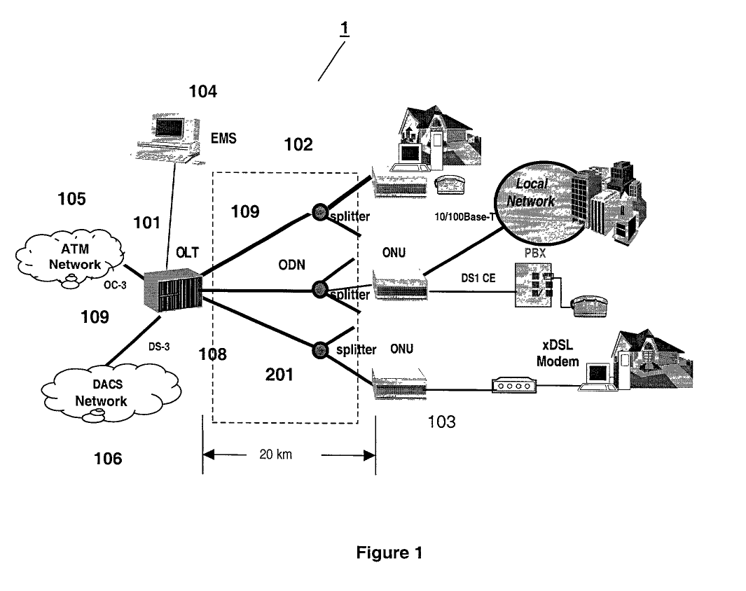

### DETAILED DESCRIPTION OF THE INVENTION

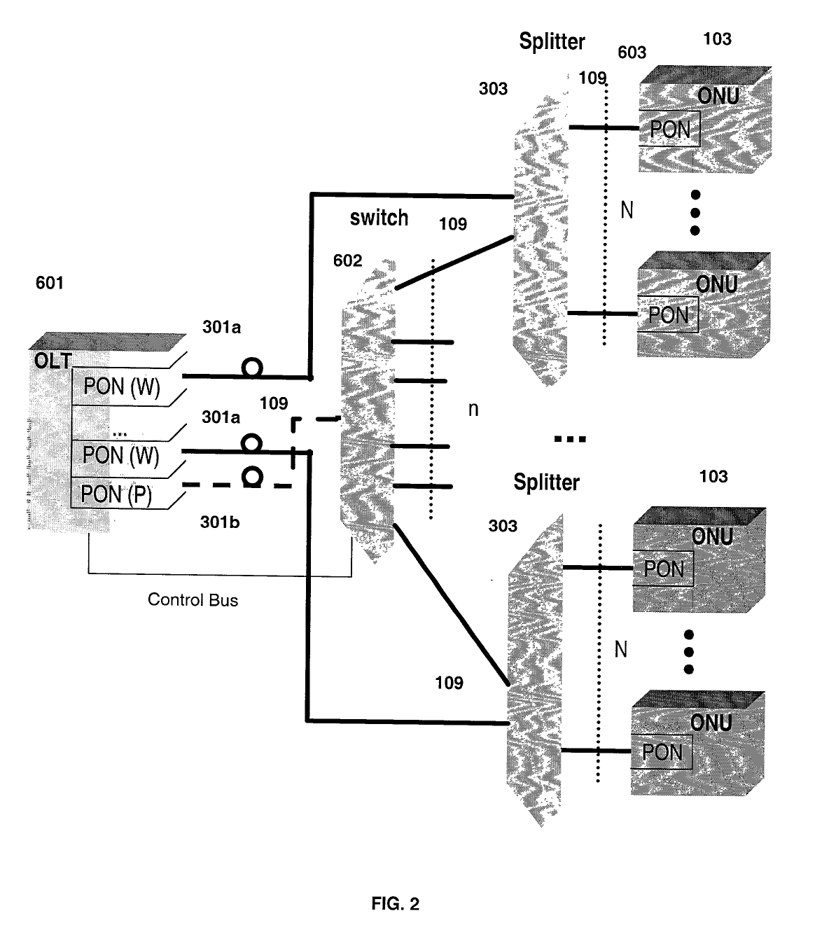

Referring now to FIG. 2, an embodiment of the present invention is shown. The OLT 101 has n working APON interface modules 301a, and one protection APON interface module 301b. The protection APON interface module 301b can be installed in a fixed slot or any slot (not shown). Each of the n working APON interface modules 301a is connected by fiber 109 to a 2:N splitter 303. Each of the 2:N splitters 303 is connected by fiber 109 to the PON interface 603 of a plurality (Nₓ) of ONUs 103. The various splitter ratios N₁ through Nₙ of the 2:N splitters 303 need not be the same. The protection APON interface module 301b is connected by fiber 109 to a 1:n optical switch 602. The 1:n optical switch 602 is connected by fiber 109 to each of the 2:N splitters 303.

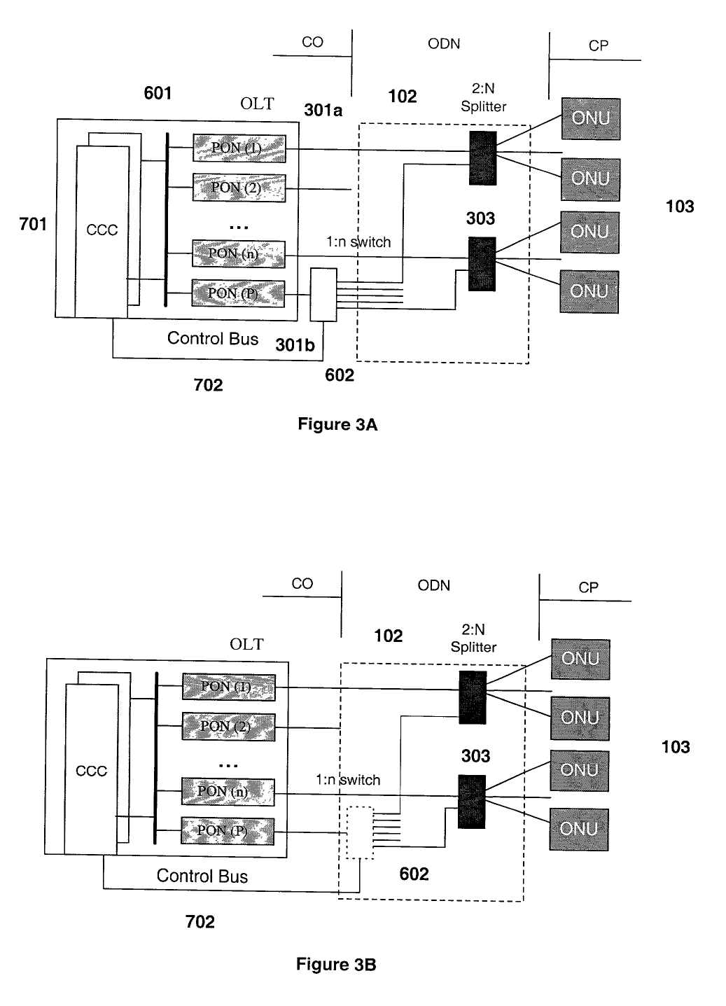

Referring now to FIG. 3a, the 1:n optical switch 602 may be installed at a Central Office (CO) (FIG. 3a) or in the field (in the ODN 102) (FIG. 3b). For the 1:n optical switch 602 that is installed at a CO, multiple fibers 109 instead of one need to be installed for the ODN 102. The 1:n optical switch 602 can be controlled locally from the OLT 601. Therefore, no active component is deployed in the ODN 102. Short root fiber connected to the 1:n optical switch 602 in an indoor environment reduces the possibilities of fiber cut. This scheme will lead to high reliability networks.

Referring now to FIG. 3b, the 1:n optical switch 602 may be alternatively installed in the field (in the ODN 102). Most optical switches based on the technologies such as Optomechanical, Mirco-Optoelectromechanical, Planer Wave Guides, Semiconductor Optical Amplification, or Liquid-Crystal, contain active components. In this case, operating the 1:n optical switch 602 in the ODN 102 will involve metallic wiring and a power supply (not shown). Hybrid or composite cables will be needed for this implementation. The benefit of this deployment is reducing the long multiple optical fibers necessary when the 1:n optical switch 602 is installed in the CO.

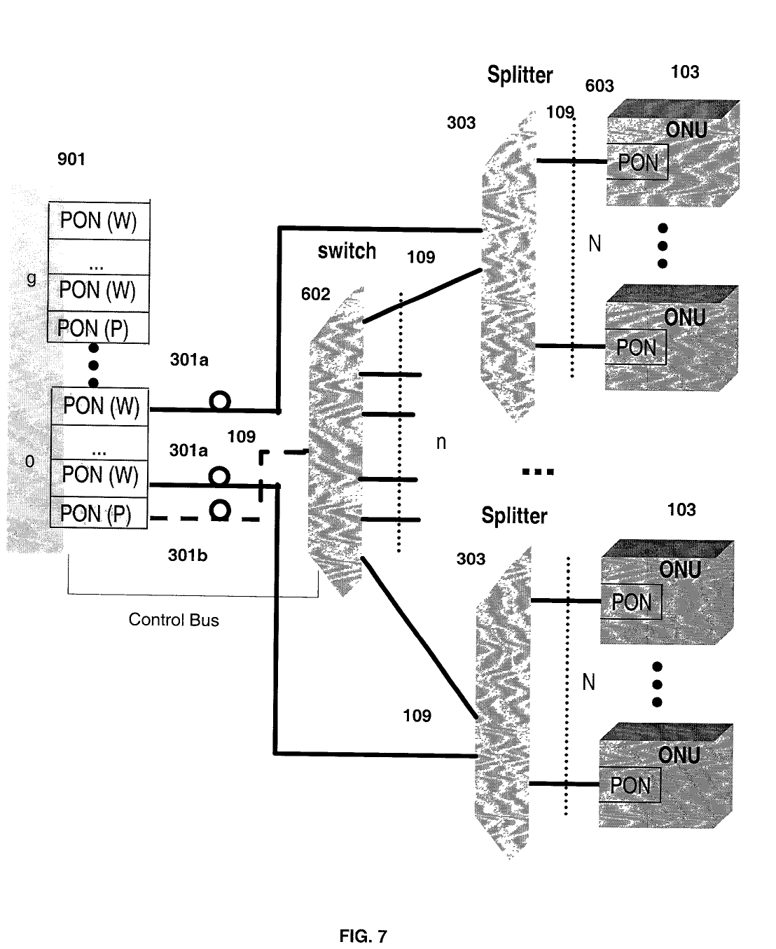

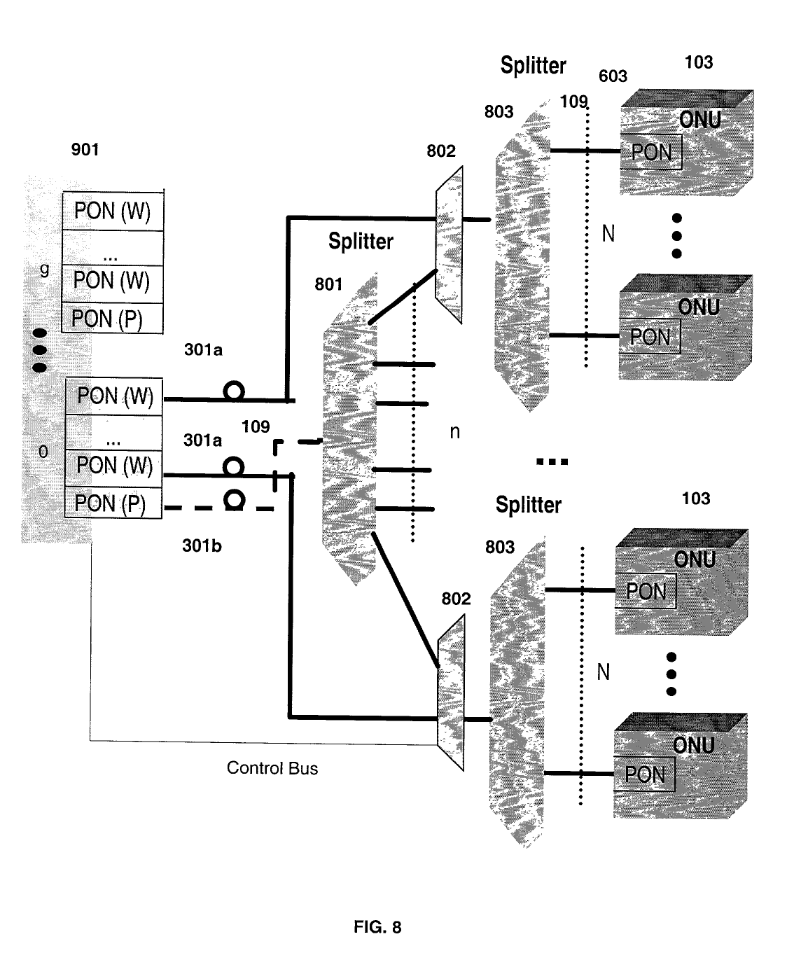

Referring now to FIGS. 7 and 8, an alternative embodiment of the arrangement shown in FIGS. 3a and 3b is shown. The OLT 901 has g groups of working APON interface modules, each group having an associated protection APON interface module. The embodiment shown in FIGS. 7 and 8 may be called g*(1:n) protection, in which the 1:n scheme show in FIGS. 3a and 3b is replicated in each of the g groups of APON interface modules.

A Common Control Card (CCC) 701 is connected to the 1:n optical switch 602 via control bus 702. The CCC 701 is also connected to the APON interface modules 301a, 301b via bus 703. Each APON interface module 301a, 301b has information associated with it which includes, but is not limited to, identification codes (PON IDs) of the PON interfaces 603 (shown in FIG. 2) with which it communicates, ONU serial numbers, ONU passwords, ranging intervals, bandwidth information, and a current alarm status. This information associated with the APON interface modules 301a, 301b will be stored in a memory in the CCC and used to supervise protection switching in the event of a system fault, such as a cut in the fiber connecting a working APON interface module 301a to a 2:N splitter 303, or an internal failure in the APON interface module 301a itself.

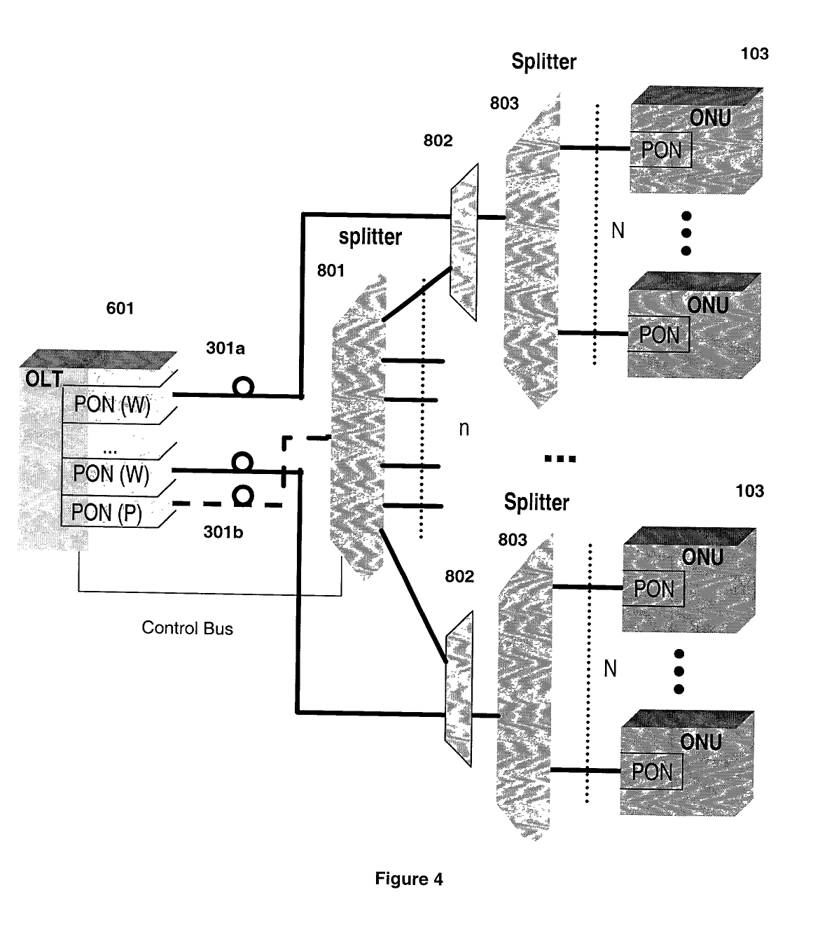

Referring now to FIG. 4, the 1:n optical switch 602 described in connection with FIGS. 2, 3a, and 3b may be replaced with a 1:n splitter 801, and a 2:1 optical switch 802 located at each of the n 1:N splitter 803, which will replace the n 2:N splitters 303 described in connection with FIGS. 2, 3a, and 3b. The 1:n optical switch solution is relative expensive and may contain active components. The 1:n splitter solution will be cost effective because one 1:n splitter plus n 2:1 optical switches are relatively cheaper than one 1:n optical switch. However, a larger power loss associated with a 1:n splitter will limit its application to small protection ratios. For example, 1:32 splitter will result in more than 15 dB power loss. For a smaller protection ratio and a short distance application, the splitter solution is more economical. Whereas for a larger protection ratio and a long distance application, using an optical switch installed at a CO will be a suitable choice.

Referring again to FIGS. 3a and 3b, the protection switching procedure controlled by the CCC 701 will be described. The procedure consists of four major portions: synchronization, failure detection, switching, and fast ranging. The synchronization functions running both at the CCC 701 and APON interface cards will keep the ONUs 103 and APON status updated. Therefore, whenever an APON interface module 301a fails, the information associated with the failed APON interface module 301a, which is stored in the CCC 701, can be recovered and copied to the protection APON interface module 301b.

As soon as a working APON interface module 301a detects a loss of signal (LOSi), it will report an alarm code to the CCC 701. Then the CCC 701 sends a control signal to the 1:n optical switch 602 creating a connection with the 1:N splitter 303 associated with the working APON interface module 301a that reported a LOSi. Therefore, the failed APON traffic can detour to the ODN via the protection APON interface module 301b. In the case of more than one working APON interface module 301a failing at the same time, the one with more traffic flow or with higher priority assigned by the operators will be switched to the protection APON interface module 301b to reduce revenue loss. The switching time is restricted so that connections on the failed working APON interface module 301a will not be dropped. For POTS service, the switching time should be less than 120 ms.

The time consumed for protection switching is very critical for quality of signal in the APON interface. To switch APON interface modules at the OLT 601 will involve performing a ranging process for multiple ONUs 103 connected. Conventional ranging of ONUs is an inherently slow process, as described in Meredith Schelp, Xudong Wang, Wei Yen, and Elton Ho, “The Ranging Protocol for ATM Passive Optical Networks: Analysis and Improvements,” Annual Multiplexes Telephony Conference (AMTC) 2000 Proceedings, July 2000.

An alternative procedure called pre-ranging, will be described. An EMS 104 orchestrates the whole process of pre-ranging. Pre-ranging is performed at the system setup period or period when the least traffic is running in the system. During system setup time, no live data traffic is running in the system. The protection APON interface module 301b can be operated as a working module for the pre-ranging purpose. The working APON interface modules 301a are switched to a standby mode one by one until all n modules are switched. The equalization data obtained for the standby module will be stored in a memory in the CCC. The advantage of this method is that all equalization data for the ONUs 103 associated with each working APON interface module 301a are readily available in the CCC memory. This will lead to fast protection switching. However, it will not always be the case that a complete new system set up can be performed. System upgrading and adding ONUs to an existing APON interface will complicate the pre-ranging process.

A second process for ranging during protection switching, called uni-ranging, will be described. Instead of ranging every ONU 103, only one ONU 103 associated with a failed APON interface module 301a will be ranged after protection switching. Since the 1:n protection at an OLT 101 is tree switching, the distance differences between to the various ONUs 103 remains intact. That is, although the total distance from the protection APON interface module 301b to a particular ONU number i may differ from the distance from the failed APON interface module to that same ONU, the differences between the distances to any two ONUs 103 is the same for both the failed APON interface module and the protection APON interface module. Therefore, after protection switching, one ONU chosen from the group can be ranged first. By comparing the previous equalization data stored at the CCC to the newly obtained range, one can calculate the equalization data for other ONUs 103 associated with the failed APON interface module. Uni-ranging speeds up the automatic switching dramatically by reducing the multiple ranging processes to one. Fine adjustment for equalization data will be performed periodically as specified by ITU G.983.1.

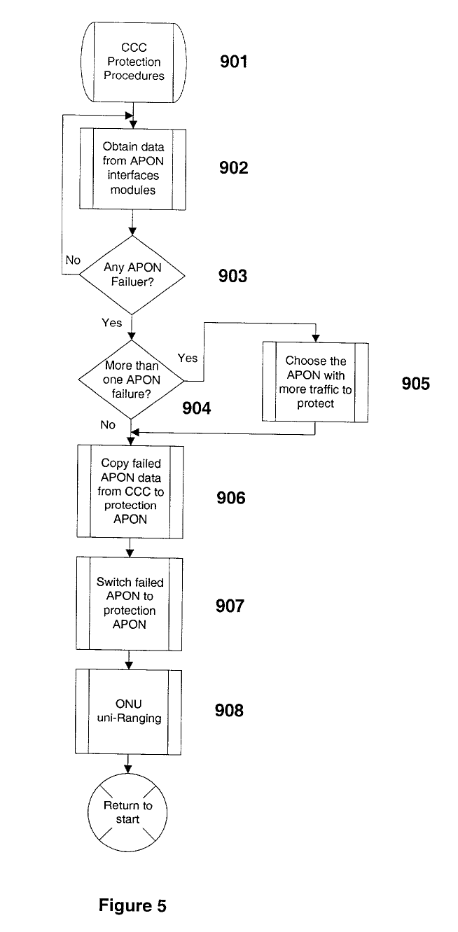

Referring now to FIG. 5, a protection management procedure will be described. The procedure is initiated by the CCC at step 901. At step 902, data associated with the working APON interface modules 301a, 301b are copied to a memory in the CCC.

At step 903, a determination is made as to whether any of the working APON interface modules 301a is in an alarm state indicating a failure. If the determination at step 903 is negative, the process returns to step 902. If the determination at step 903 is positive, the process proceeds to step 904.

At step 904, a determination is made as to whether more than one working APON interface module is in an alarm state indicating a failure. If the determination at step 904 is negative, the procedure proceeds directly to step 906. If the determination at step 904 is positive, the procedure proceeds to step 905.

At step 905, a determination is made about which of the multiple failed APON interface modules to protect. This determination may be made, for example, by determining which failed APON interface module was handling the greatest amount of traffic. Alternatively, this determination may be made by determining which failed APON interface module was handling the traffic with the highest priority. After the determination at step 905, the procedure proceeds to step 906.

At step 906, the protection APON interface module 301b receives from the CCC a copy of the data for ONUs 103 connected to the failed APON interface module. The data has been previously stored at the CCC and updated periodically through synchronization functions running at the CCC and APON interface modules.

At step 907, control is switched from the failed APON interface module to the protection APON interface module 301b. In the embodiment shown in FIGS. 3a and 3b, a signal is sent to the 1:n optical switch 602 to make a connection between the protection APON interface module 301b and the 2:N splitter 303 associated with the failed APON interface module. In the embodiment shown in FIG. 4, a signal is sent to one of the 2:1 optical switches to make a connection between the protection APON interface module 301b and the 1:N splitter 803 associated with the failed APON interface module.

At step 908, the uni-ranging process begins.

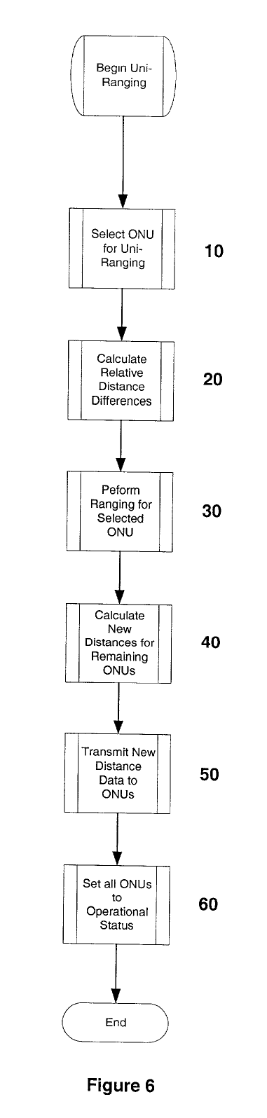

Referring now to FIG. 6, the details of the uni-ranging process will be described. At step 10, an ONU 103 from the group associated with the failed APON interface module is chosen for uni-ranging. For example, the selected ONU can be the one with the shortest distance or the smallest serial number. The chosen ONU will be referred as the uni-ONU.

At step 20, the distance difference represented by phase equalization data will be calculated based on the chosen uni-ONU. The distance may be calculated as follows:

ΔTdⱼᵢ=Tdⱼ−Tdᵢ;

where j ∈ [1, N], and i represents the uni-ONU number and N is the splitter ratio of the 2:N splitter 303, for example.

At step 30, the ranging of the uni-ONU is performed. If the uni-ONU's serial number is known and stored in the CCC and transferred to the protection APON interface module, the ranging mask may be sent to the uni-ONU only, thus avoiding a time-consuming binary tree search. After ranging, the new phase equalization data, Tdᵢ′, for the uni-ONU should be obtained.

At step 40, new distances of the rest of the ONUs 103 associated with the failed APON interface module are calculated. Based on the new phase equalization data of the uni-ONU, all distances for the other ONUs 103 which are associated with the failed APON interface module can be calculated. The new distances may be calculated as follows:

Tdⱼ′=Tdᵢ′+ΔTdⱼᵢ;

where j ∈ [1, N], and i represents the uni-ONU number, N is the splitter ratio of the 2:N splitter 303, for example, and Tdⱼ′ is the new phase equalization data for ONU number j.

At step 50, the new equalization data, Tdⱼ′, is sent to the ONUs 103 with triple redundancy from the protection APON interface module 301b at the OLT 601. The ONUs 103 will use the new value Tdⱼ′ for distance compensation.

At step 60, the ONUs 103 are set into operational status.

While the invention has been described in its preferred embodiments, it is understood that the words which have been used are words of description, rather than limitation, and that changes may be made without departing from the true scope and spirit of the invention in its broader aspects. Thus, the scope of the present invention is defined by the claims that follow.

What is claimed is:

1. A telecommunications network comprising:
a plurality of primary interface modules;
a protection interface module;
a plurality of optical splitters;
an optical switch;
a first plurality of optical fibers each having a first end coupled to one of the plurality of primary interface modules and a second end coupled to one of the plurality of optical splitters;
a second plurality of optical fibers each having a first end coupled to the optical switch and a second end coupled to one of the plurality of optical splitters; and
a third optical fiber coupling the protection interface module and the optical switch.

2. The telecommunications network of claim 1 further comprising:
means for detecting a failure of one of the first plurality of optical fibers; and
means for controlling the optical switch to provide an alternate communications route in response to the detection of a failure by the means for detecting.

3. The telecommunications network of claim 1 further comprising:
means for detecting a failure of one of the plurality of primary interface modules; and
means for controlling the optical switch to provide an alternate communications route in response to the detection of a failure by the means for detecting.

4. The telecommunications network of claim 1 further comprising:
a plurality of optical network units each having a network interface module; and
a third plurality of optical fibers,
wherein the plurality of optical splitters are 2:n splitters, each 2:n splitter having a network side having two interfaces and a user side having a plurality of downstream interfaces, and
wherein each 2:n splitter has one of the first plurality of optical fibers coupled to one network-side interface, and one of the second plurality of optical fibers is coupled to the other network-side interface, and
wherein a least one of the third plurality of optical fibers has a first end coupled to one of the user-side interfaces and a second end coupled to one of the network interface modules.

5. A telecommunications network comprising:
a plurality of primary interface modules;
a protection interface module;
a first optical splitter;
a second plurality of optical splitters;
a plurality of optical switches;
a first plurality of optical fibers each having a first end coupled to one of the plurality of primary interface modules and a second end coupled to one of the plurality of optical switches;
a second plurality of optical fibers each having a first end coupled to the first optical splitter and a second end coupled to one of the plurality of optical switches;
a third plurality of optical fibers each having a first end coupled to one of the plurality of optical switches and a second end coupled to one of the second plurality of optical splitters; and
a fourth optical fiber coupling the protection interface module and the first optical splitter.

6. The telecommunications network of claim 5 further comprising:
means for detecting a failure of one of the first plurality of optical fibers; and
means for controlling one of the plurality of optical switches associated with the failed one of the first plurality of optical fibers to provide an alternate communications route in response to the detection of a failure by the means for detecting.

7. The telecommunications network of claim 5 further comprising:
means for detecting a failure of one of the plurality of primary interface modules; and
means for controlling one of the plurality of optical switches associated with the failed one of the plurality of primary interface modules to provide an alternate communications route in response to the detection of a failure by the means for detecting.

8. The telecommunications network of claim 5 further comprising:
a plurality of optical network units each having a network interface module; and
a fifth plurality of optical fibers,
wherein the second plurality of optical splitters are 1:n splitters having a network-side interface and a plurality of user-side interfaces, and
wherein each 1:n splitter has one of the third plurality of optical fibers coupled to the network-side interface, and
wherein a least one of the fifth plurality of optical fibers has a first end coupled to one of the user-side interfaces and a second end coupled to one of the network interface modules.

9. The telecommunications network of claim 5, wherein each of the plurality of optical switches are 2:1 switches.

10. A method for protecting a network from failures comprising the steps of:
receiving data about the working status of the network;
detecting one or more failures in the network;
associating one or more primary interface modules with respective one or more of the failures after the detection of the failures;
copying the operational data of one of the primary interface modules associated with one of the failures to a protection interface module;
switching control of communications from the primary interface module whose operation data was copied to a protection interface module.

11. The method of claim 10, wherein the step of copying further comprises the steps of:
associating a plurality of network interface modules with the one of the failures;
selecting a network interface module from the plurality of network interface modules;
calculating relative distance data comprising differences in distances from the primary interface modules associated with one of the failures to the plurality of network interface modules;
determining the distance from the protection interface module to the selected network interface module;
calculating new the distances to all other network interface modules besides the selected network interface module based on the determined distance from the protection interface module to the selected network interface module and the relative distance data.

12. The method of claim 11 wherein the first step of calculating further comprises:
reading a stored distance value for each for the plurality of network interface modules; and
calculating the difference between the stored distance value for the selected network interface module and the stored distance values for all the other network interface modules.

13. The method of claim 11 wherein the second step of calculating further comprises adding the determined distance from the protection interface module to the selected network interface module to the relative distance data for each of the other network interface modules.

14. The method of claim 11 wherein:
the first step of calculating further comprises reading a stored distance value for each for the plurality of network interface modules and calculating the difference between the stored distance value for the selected network interface module and the stored distance values for all the other network interface modules; and
the second step of calculating further comprises adding the determined distance from the protection interface module to the selected network interface module to the relative distance data for each of the other network interface modules.

15. The method of claim 10, wherein the step of copying further comprises the steps of:
ranking the primary interface modules associated with the failures when more than one failure is detected; and
copying the operational data of the primary interface module having the highest rank to a protection interface module.

16. The method of claim 15, wherein the step of ranking comprises assigning a rank according to the amount of network traffic which was being handled by the respective primary interface modules associated with the failures.

17. The method of claim 15, wherein the step of ranking comprises assigning a rank according to the priority of data which was being handled by the respective primary interface modules associated with the failures.

18. The method of claim 10, wherein the step of detecting further comprises the step of detecting the failure of one or more primary interface modules.

19. The method of claim 10, wherein the step of detecting further comprises the step of detecting the failure of one or more optical fibers.

20. An optical line terminator comprising:
a control card;
a plurality of primary interface modules coupled to the control card; and
a protection interface module coupled to the control card, wherein the control card further comprises a processor;
a first memory storing operational data associated with the plurality of primary interface modules;
a second memory containing program instructions executable by the processor for performing the steps of receiving data about the working status of the network;
detecting one or more failures in the network;
associating one or more of the primary interface modules with respective one or more of the failures after the detection of the failures;
copying the operational data of one of the primary interface modules associated with one of the failures to a protection interface module;
switching control of communications from the primary interface module whose operation data was copied to the protection interface module.

21. The optical line terminator of claim 20 wherein the step of copying further comprises the steps of:
associating a plurality of network interface modules with the one of the failures;
selecting a network interface module from the plurality of network interface modules;
calculating relative distance data comprising differences in distances from the primary interface modules associated with one of the failures to the plurality of network interface modules;
determining the distance from the protection interface module to the selected network interface module;
calculating new the distances to all other network interface modules besides the selected network interface module based on the determined distance from the protection interface module to the selected network interface module and the relative distance data.

22. A method for ranging network interface modules comprising the steps of:
selecting a network interface module from a plurality of network interface modules;
calculating relative distance data comprising differences in distances from a first point to the plurality of network interface modules;
determining the distance from a second point to the selected network interface module;
calculating new the distances to all other network interface modules besides the selected network interface module based on the determined distance from the second point to the selected network interface module and the relative distance data.

23. The method of claim 22 wherein the step of calculating relative distance data further comprises:
reading a stored distance value for each for the plurality of network interface modules; and
calculating the difference between the stored distance value for the selected network interface module and the stored distance values for all the other network interface modules.

24. The method of claim 22 wherein the step of calculating the new distance further comprises adding the determined distance from the second point to the selected network interface module to the relative distance data for each of the other network interface modules.

25. The method of claim 22 wherein:
the step of calculating relative distance data further comprises reading a stored distance value for each of the plurality of network interface modules and calculating the difference between the stored distance value for the selected network interface module and the stored distance values for all the other network interface modules; and
the step of calculating the new distance further comprises adding the determined distance from the second point to the selected network interface module to the relative distance data for each of the other network interface modules.

26. A method for ranging network interface modules for a network comprising the steps of:
determining range data for each network interface module associated with a plurality of primary interface modules during a period when there is low traffic on the network; and
storing the determined range data in a memory of a control card which is coupled to all of the primary interface modules and a protection interface module.

27. A telecommunications network comprising:
one or more network groups,
wherein each network group further comprises
a plurality of primary interface modules;
a protection interface module;
a plurality of optical splitters;
an optical switch;
a first plurality of optical fibers each having a first end coupled to one of the plurality of primary interface modules and a second end coupled to one of the plurality of optical splitters;
a second plurality of optical fibers each having a first end coupled to the optical switch and a second end coupled to one of the plurality of optical splitters; and
a third optical fiber coupling the protection interface module and the optical switch.

28. The telecommunications network of claim 27 further comprising:
means for detecting a failure of one of the first plurality of optical fibers; and
means for controlling the optical switch to provide an alternate communications route in response to the detection of a failure by the means for detecting.

29. The telecommunications network of claim 27 further comprising:
means for detecting a failure of one of the plurality of primary interface modules; and
means for controlling the optical switch to provide an alternate communications route in response to the detection of a failure by the means for detecting.

30. The telecommunications network of claim 27 further comprising:
a plurality of optical network units each having a network interface module; and
a third plurality of optical fibers,
wherein the plurality of optical splitters are 2:n splitters, each 2:n splitter having a network side having two interfaces and a user side having a plurality of downstream interfaces, and
wherein each 2:n splitter has one of the first plurality of optical fibers coupled to one network-side interface, and one of the second plurality of optical fibers is coupled to the other network-side interface, and
wherein a least one of the third plurality of optical fibers has a first end coupled to one of the user-side interfaces and a second end coupled to one of the network interface modules.

31. A telecommunications network comprising:
one or more network groups, each network group further comprising
a plurality of primary interface modules;
a protection interface module;
a first optical splitter;
a second plurality of optical splitters;
a plurality of optical switches;
a first plurality of optical fibers each having a first end coupled to one of the plurality of primary interface modules and a second end coupled to one of the plurality of optical switches;
a second plurality of optical fibers each having a first end coupled to the first optical splitter and a second end coupled to one of the plurality of optical switches;
a third plurality of optical fibers each having a first end coupled to one of the plurality of optical switches and a second end coupled to one of the second plurality of optical splitters; and
a fourth optical fiber coupling the protection interface module and the first optical splitter.

32. The telecommunications network of claim 31 further comprising:
means for detecting a failure of one of the first plurality of optical fibers; and
means for controlling one of the plurality of optical switches associated with the failed one of the first plurality of optical fibers to provide an alternate communications route in response to the detection of a failure by the means for detecting.

33. The telecommunications network of claim 31 further comprising:
means for detecting a failure of one of the plurality of primary interface modules; and
means for controlling one of the plurality of optical switches associated with the failed one of the plurality of primary interface modules to provide an alternate communications route in response to the detection of a failure by the means for detecting.

34. The telecommunications network of claim 31 further comprising:
a plurality of optical network units each having a network interface module; and
a fifth plurality of optical fibers,
wherein the second plurality of optical splitters are 1:n splitters having a network-side interface and a plurality of user-side interfaces, and
wherein each 1:n splitter has one of the third plurality of optical fibers coupled to the network-side interface, and
wherein a least one of the fifth plurality of optical fibers has a first end coupled to one of the user-side interfaces and a second end coupled to one of the network interface modules.

35. The telecommunications network of claim 31, wherein each of the plurality of optical switches are 2:1 switches.
